(19) United States
(12) Patent Application Publication
(10) Pub. No.: US 2010/0165671 A1
(43) Pub. Date: Jul. 1, 2010

(54) Switched-mode Power Supplies

(75) Inventors: David Robert Coulson, Cambridge (GB); Antonius J.J. Werner, Cambridge (GB); Vladimir Alexiev, Cambridge (GB)

Correspondence Address: Clise, Billion & Cyr, P.A., 605 U.S. Highway 169, Suite 300, Plymouth, MN, 55441, US

(73) Assignee: Cambridge Semiconductor Limited, Cambridge (GB)

(21) Appl. No.: 12/492,451

(22) Filed: Jun. 26, 2009

(30) Foreign Application Priority Data
Jun. 30, 2008 (GB) GB0811895.2

(51) Int. Cl. H02M 3/335

(52) U.S. Cl. 363/21.12

(57) ABSTRACT

This disclosure relates to switched-mode power supplies, to transformers for such power supplies, and to methods of operating switched-mode power supplies. A switch mode power supply (SMPS), the switched-mode power supply having a power input, a switch, a transformer, and a power output; said transformer having a primary winding on a primary side of said power supply coupled to said power input via said switch, and a secondary winding on a secondary side of said switched-mode power supply coupled to said power output; wherein said transformer further includes first and second auxiliary windings, wherein said first auxiliary winding is more closely coupled to said primary winding than to said secondary winding and wherein said second auxiliary winding is more closely coupled to said secondary winding than to said primary winding.

### FIELD OF THE INVENTION

This invention relates to switched-mode power supplies, to transformers for such power supplies, and to methods of operating switched-mode power supplies.

### BACKGROUND TO THE INVENTION

The design of switched-mode power supplies (SMPS) requires careful attention to be paid to voltage transients appearing across each primary switch, to ensure that limits for peak switch voltage and EMC RF emissions are not exceeded. There is a wide range of circuit arrangements which are used to manage both the peak voltage and the rate of voltage rise across the primary switch, which may be classified as snubbers, which work by dissipating the unwanted transient energy, and clamping circuits, which recycle some of the transient energy for re-use on subsequent cycles.

It is desirable to minimise the amount of power dissipated in a snubber circuit, because this directly impacts the efficiency of the overall SMPS. It is also desirable to minimise the total system cost of any SMPS, particularly in high volume applications, where the snubber components form a significant proportion of the total system cost.

We describe methods which allow the power dissipated in the snubber to be significantly reduced, increasing the overall system efficiency. In many cases, it is also possible to completely remove the snubber circuit, not only increasing conversion efficiency but also reducing system component costs.

The unwanted RF emissions from a SMPS have to be controlled to meet statutory requirements and are attributable to a number of switching sources, the largest contributor being typically the primary switch. Embodiments of the method we describe reduce the rate of rise of the primary switch voltage, which has a beneficial effect upon the RF emissions.

General background prior art relating to switching regulators and transformer design can be found in: U.S. Pat. No. 7,310,244; U.S. Pat. No. 7,256,675; U.S. Pat. No. 4,679,132; US2007/0152794; EP1239578; and US2008/0219033.

### SUMMARY OF THE INVENTION

According to the present invention there is therefore provided a switch mode power supply (SMPS), said switched-mode power supply having a power input, a switch, a transformer, and a power output; said transformer having a primary winding on a primary side of said power supply coupled to said power input via said switch, and a secondary winding on a secondary side of said switched-mode power supply coupled to said power output; wherein said transformer further comprises first and second auxiliary windings, wherein said first auxiliary winding is more closely coupled to said primary winding than to said secondary winding and wherein said second auxiliary winding is more closely coupled to said secondary winding than to said primary winding.

Embodiments of such a switched-mode power supply help to address the twin, conflicting aims of accurately sensing the secondary side voltage without seeing the ringing present if using a primary side winding for such sensing, and deriving power for powering a controller of the switched-mode power supply in such a way that the controller is not left unpowered if the output voltage of the SMPS falls to substantially zero.

In embodiments, therefore, the first auxiliary winding is used to derive power for powering the controller. In some preferred embodiments this first auxiliary winding is substantially directly connected to a rectifier (rather than via an intermediate, low value resistor) and thence to a smoothing capacitor. This enables power to be harvested from parasitic elements of the SMPS, in particular one or both of the leakage inductance and stray capacitance of the SMPS. More particularly, in embodiments the energy in the ringing seen in a voltage from a winding (the first auxiliary winding) closely coupled to the primary winding is harvested to provide power substantially irrespective of the output voltage of the SMPS. This ringing has previously been considered a problem, the associated energy simply being dissipated within the windings.

One advantage of embodiments of the invention is that a simple snubber circuit may be employed, and in some embodiments a snubber may even be omitted. In embodiments snubbing action may be achieved by clamping the closely-coupled auxiliary power winding to the primary winding, for example using a zener diode. Thus embodiments of the switched-mode power supply include a voltage clamping component or circuit connected to the auxiliary winding to provide at least partial clamping of the switched primary winding.

A desirable characteristic for some switched-mode power supplies is a constant voltage, constant current characteristic, that is a characteristic (in an ideal case) in which the output voltage is substantially constant until a threshold output current is reached, at which the output current is substantially constant as the output voltage decreases to zero with a short circuit. In practice the output current falls to zero in the vicinity of zero volts output; in a poorly regulated power supply the output voltage and output current may fall substantially linearly over a substantial portion of the range of the output voltage decreasing towards zero. Embodiments of the techniques we describe enable a close to ideal response because they facilitate control of the power supply even when the output voltage is very low, even when for example the output voltage approaches or falls to substantially zero (say less than 20%, 10%, 5% or 3% of its maximum value at a constant output current).

Thus in a related aspect there is provided a switched-mode power supply (SMPS) said switched-mode power supply having a power input, a switch, a controller to control said switch, a transformer, and a power output; said transformer having a primary winding on a primary side of said power supply and coupled to said power input via said switch, and a secondary winding on a secondary side of said power supply coupled to said power output, wherein said transformer further comprises an auxiliary winding to provide a power supply for said controller, wherein said SMPS has an output characteristic including a substantially constant current portion in which an output voltage of said SMPS falls towards zero at substantially constant output current with increasing output load, and wherein said power supply for said controller is configured to provide power for said controller as said output voltage falls from a maximum value at said substantially constant output current to a voltage of less than one third of said maximum value.

In embodiments a substantially constant output current may be provided to an output voltage of less than 20%, 10%, 5% or 3% of a maximum (constant voltage) value at the constant output current.

It is also desirable to be able to accurately sense the output voltage of the power supply, and in embodiments this is achieved by closely coupling the second auxiliary winding to the secondary winding of the transformer. This has the advantage that the ringing, which would otherwise be seen by an auxiliary winding closely coupled to the primary winding, is suppressed. In some preferred implementations the transformer includes a spacer to physically separate the first and second auxiliary windings (and the primary and secondary windings) from one another. However there is a conflicting aim of coupling power from the primary to the secondary winding and therefore such a spacer may be adjustable, for example comprising a variable number of layers of tape. To a degree there is a trade off between good coupling of power from the primary to the secondary, and interference by the primary winding flux with the second auxiliary winding, and by the secondary winding flux with the first auxiliary winding.

In preferred embodiments the first auxiliary winding is closely coupled to the primary winding; preferably in a similar way the second auxiliary winding and secondary winding are also closely coupled. In embodiments this may be achieved by interleaving layers or turns of the respective pairs of winding or by employing one or more bifilar windings. In embodiments the secondary winding is double or triple insulated to provide good isolation between the primary and secondary sides of the switched-mode power supply.

In some preferred implementations the two auxiliary windings are connected in series with one another, either in the same sense or in an opposite sense.

In a related aspect the invention provides a method of providing a power supply to the controller of a switched-mode power supply (SMPS), said switched-mode power supply having a power input, a switch, a transformer and a power output; said transformer having a primary winding on a primary side of said power supply coupled to said power input via said switch, and a secondary winding on a secondary side of said switched-mode power supply coupled to said power output, wherein said transformer further comprises an auxiliary winding, in operation of said SMPS said auxiliary winding having a voltage waveform with a ringing component when said switch turns off, said ringing component comprising energy stored in leakage inductance and stray capacitance of said SMPS, the method comprising extracting energy to power said controller of said SMPS from said ringing component of said auxiliary winding voltage.

In embodiments of the method a rectifier coupled to the auxiliary winding clips the ringing to harvest energy from one or both leakage inductance and stray capacitance of the SMPS. The energy available from the leakage inductance is dependent on the peak primary current (Iₚₚ) and this in turn reduces at low output loads on the SMPS. However this is not a significant problem because at low output loads the output voltage of the SMPS is high, for example at its constant output voltage level, and therefore at low output loads it is not necessary to derive energy from the ringing.

One useful advantage of closely coupling the auxiliary winding powering the SMPS controller with the primary winding is the relatively significant level of stray capacitance this provides, in particular the capacitance between the auxiliary winding and the hot (that is, switched) end of the primary winding. This stray capacitance can be used to recover power which is proportional to the square of the voltage on the switch, for example the collector voltage of the switching transistor, the capacitance, and the frequency of the operation of the power supply. Thus this stray capacitance provides an additional energy contribution to help power the controller. Depending upon the configuration of the SMPS this may be as much as 100 mW or more.

In a related aspect the invention provides a switched-mode power supply, said switched-mode power supply having a power input, a switch, a controller to control said switch, a transformer, and a power output; said transformer having a primary winding on a primary side of said power supply coupled to said power input via said switch, and a secondary winding on a secondary side of said switched-mode power supply coupled to said power output, and wherein said transformer further comprises an auxiliary winding to provide a power supply for said controller, in operation of said SMPS said auxiliary winding having a voltage waveform with a ringing component when said switch turns off, said ringing component comprising energy stored in leakage inductance and stray capacitance of said SMPS, said switched-mode power supply further comprising means for extracting energy to power said controller of said SMPS from said ringing component of said auxiliary winding voltage.

The skilled person will also understand that it is desirable to reduce radio frequency emissions from an SMPS. One technique which can be employed is to provide a copper foil adjacent to each of the primary and secondary windings, each connected to a quiet point on respective primary and secondary sides of the power supply. (Such a quiet point is sometimes referred to as primary ground, primary quiet or primary reference, with corresponding points on the secondary side, and may comprise a zero volts or ground connection). The copper foils have capacitance to the respective windings with which they are associated. Their operation can be understood by considering what would happen if the foils were connected to different, noisy points in the power supply—a large noise current would flow. In effect the capacitors formed short out the noise. However such an arrangement adds to the cost of the power supply, which is typically heavily constrained.

According to a further related aspect the invention provides a method of suppressing emissions from a switched-mode power supply (SMPS) said switched-mode power supply having a power input, a switch, a transformer, and a power output; said transformer having a primary winding on a primary side of said power supply coupled to said power input via said switch, and a secondary winding on a secondary side of said power supply coupled to said power output, wherein said transformer further comprises an auxiliary winding to sense a voltage on said secondary side of said SMPS, and wherein said SMPS includes a controller to control said switch in response to said sensed voltage, the method comprising winding said auxiliary winding interleaved with said secondary winding and coupling each of said secondary winding and said auxiliary winding to a reference voltage connection on respectively said secondary side and said primary side of said SMPS.

The invention still further provides a switched-mode power supply said switched-mode power supply having a power input, a switch, a transformer, and a power output; said transformer having a primary winding on a primary side of said power supply coupled to said power input via said switch, and a secondary winding on a secondary side of said power supply coupled to said power output, wherein said transformer further comprises an auxiliary winding, wherein said auxiliary winding is interleaved with said secondary winding, and wherein each of said secondary winding and said auxiliary winding is coupled to a reference voltage connection on respectively said secondary side and said primary side of said SMPS.

Broadly speaking by employing two windings, one coupled to the mains side of the power supply and one to the low voltage side of the power supply, each bearing substantially the same voltages (with substantially the same phases), because there is substantially no differential voltage between these windings (the voltages on them go up and down together) noise current is suppressed.

The techniques we describe are particularly useful in primary side sensing switched-mode power supplies. In some preferred implementations the SMPS is a flyback type SMPS (in which case the transformer acts as an energy transfer element, and in which the primary and secondary windings have opposite polarities). However the techniques we describe are also useful in forward converter type switched-mode power supplies (in which the primary and secondary windings have the same polarity). The techniques we describe are not limited to any particular SMPS topology.

### BRIEF DESCRIPTION OF THE DRAWINGS

These and other aspects of the invention will now be further described, by way of example only, with reference to the accompanying figures in which:

FIG. 1 shows an example of a switched-mode power supply (SMPS) employing primary side sensing to detect the SMPS output voltage;

FIGS. 2a and 2b show, respectively, a simplified schematic circuit diagram of a flyback SMPS, and voltage and current wave forms for the primary and auxiliary power windings of the SMPS of FIG. 2a;

FIG. 3 shows a simplified schematic circuit diagram of an SMPS with auxiliary winding loading;

FIG. 4 shows a schematic diagram of a transformer for the SMPS of FIG. 3;

FIG. 5 shows an example partial cross section through the transformer of FIG. 4, illustrating the auxiliary power winding;

FIGS. 6a and 6b show respectively, a partial cross section through a transformer including an auxiliary sensing winding, and an illustration of the location of the cross section of FIG. 6a in the context of a more complete transformer cross section;

FIG. 7 shows transformer voltages and currents for an SMPS including a transformer of the type shown in FIG. 6, with an auxiliary sense winding;

FIG. 8 shows a schematic circuit diagram of an example of a primary side sensing switched-mode power supply incorporating the embodiment of a transformer according to the invention;

FIGS. 9a and 9b, show, respectively, a schematic diagram of the transformer of the SMPS of FIG. 8, and a partial cross section through the transformer illustrating a construction and disposition of the windings; and

FIG. 10 shows measured noise level signals from the SMPS of FIG. 8.

### DETAILED DESCRIPTION OF THE PREFERRED EMBODIMENTS

Broadly speaking we will describe a transformer winding structure which provides a means of closely coupling the primary and auxiliary windings by capacitive and inductive means. In a switch-mode power supply circuit, a significant portion of the switch-off transient energy may be transferred by the capacitive and inductive coupling to the primary circuit for possible re-use. The switch-off transient energy appearing across the primary switch is reduced, resulting in a slower voltage rise-time and a smaller voltage overshoot, permitting the reduction or elimination of voltage limiting components associated with the primary switch.

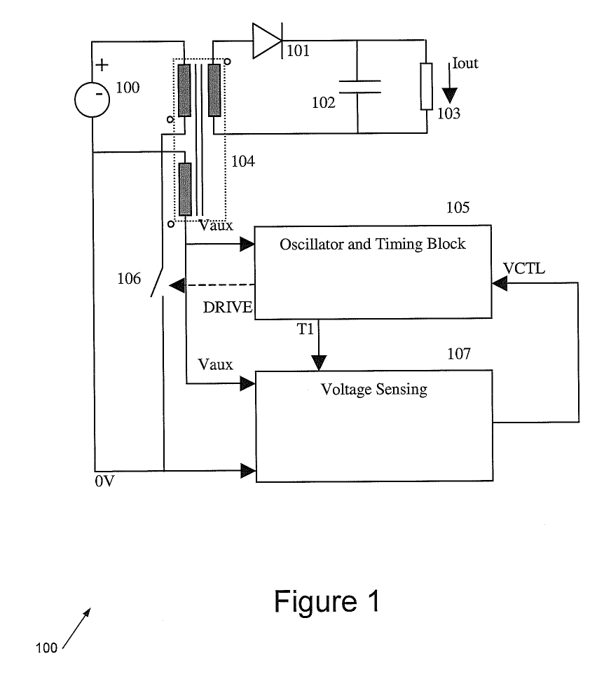

It is helpful to provide some context useful for understanding embodiments of the invention. Thus referring to FIG. 1, this shows a block diagram of an example of a flyback single-switch SMPS 100 incorporating primary side voltage sensing.

A DC source 100 is connected to the primary winding of a transformer in series with a primary side switch 106. The secondary winding of the transformer is connected to an output diode 101 in series with a capacitor 102. A load, represented by a resistor 103 is connected across the output capacitor 102. One end of an auxiliary winding on the transformer 104 is connected between the negative terminal of the DC supply 100 and the other end “VAUX” is connected to an Oscillator and Timing Block 105 and to a Voltage Sense Block 107.

The Voltage Sense Block 107 generates a signal (or value) VCTL representing the required level of output power, from signals VAUX and T1. The VCTL signal is fed back to the Oscillator and Timing Block which generates a DRIVE pulse for switch 106 at an appropriate frequency and duration.

In embodiments the timing signal T1 is derived from the VAUX signal, providing the timing control for the Voltage Sense Block 107. Typically T1 is driven active shortly after VAUX goes positive (allowing time for the initial overshoot waveform artefacts to decay), for example based on a comparison of VAUX with zero or on the DRIVE signal. T1 may be driven inactive when VAUX goes negative again. For example, a comparator may be employed to identify a negative-going zero-crossing of VAUX to drive T1 inactive. Timing signal T1 may be generated either by oscillator block 105 or within voltage sensing block 107.

As previously mentioned, the Oscillator and Timing Block 105 uses the input VCTL to control the frequency and pulse duration applied to the DRIVE output, which controls the main primary switch 106. As the skilled person will understand, the Oscillator and Timing Block 105 may be implemented in many different ways; examples of some particularly advantageous techniques are described in the Applicant's patent applications WO 2007/003967, WO 2006/067523, WO 2007/135457, and WO 2007/135457, all hereby incorporated by reference. Current sensing may be performed by a current sense resistor in series with the primary side switch; some preferred examples of output current control techniques which may be employed are described in our patent applications GB0809410.4 and GB0809410.4, both also hereby incorporated by reference.

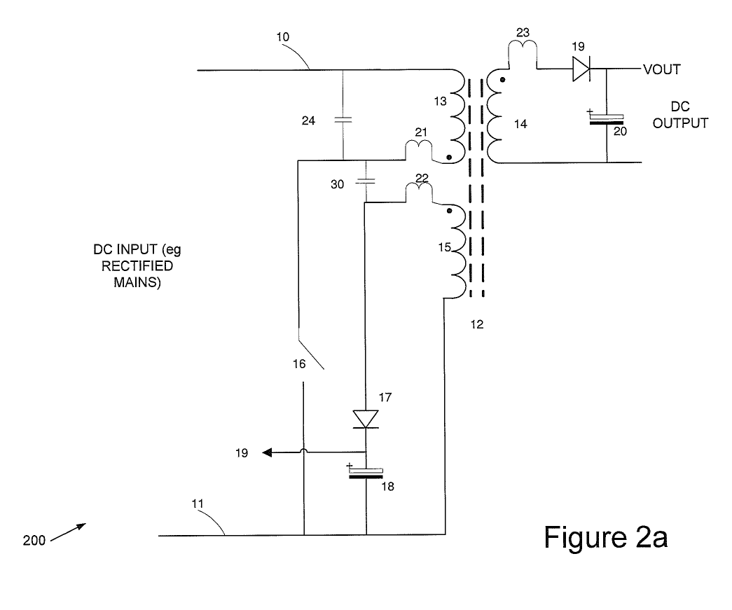

Referring now to FIG. 2a, this shows a simplified circuit diagram of a portion of a flyback SMPS 200.

The primary winding (13) is the winding on the primary (input) side of the transformer, by which the power is brought into the transformer. The secondary winding (14) is the winding on the secondary side of the transformer, from which most of the output power is drawn. The auxiliary winding (15) is the winding on the primary side of the transformer, from which a relatively small amount of power is drawn in order to supply the control circuits.

Harvesting Useful Power from Parasitic Elements

Associated with each transformer winding, there is a leakage inductance (21, 22, 23) and interwinding capacitance (24), which tends to add oscillatory artefacts to the power conversion voltage waveforms in a typical operating SMPS. For example, in a flyback power supply circuit (see schematic in FIG. 2a), the energy in the leakage inductance and primary winding capacitance cause ringing to the primary switching waveform as shown in FIG. 2b. It can be seen that in FIG. 2a winding 15 is directly connected to rectifier 17, without an intervening resistor.

The energy stored in the primary (magnetisation) inductance (L_{M}) when the primary current reaches a peak value I_{PP} is given by the equation:

$${E}_{M} = \frac{1}{2} \cdot {L}_{M} \cdot {I}_{PP}^{2}$$

This is independent of the SMPS output voltage V_{OUT}. In most SMPS applications, this magnetisation energy can be transferred efficiently to the output as useful energy. If the primary switch is cycled with a frequency of F, the power thus transferred is given by the equation:

$${P}_{M} = \frac{1}{2} \cdot {L}_{M} \cdot {I}_{PP}^{2} \cdot F$$

Similarly, the energy stored in the leakage inductance when the primary current reaches a peak value I_{PP} is given by the equation:

$${E}_{LP} = \frac{1}{2} \cdot {L}_{LP} \cdot {I}_{PP}^{2}$$

The leakage power (which is not transferred to the output) is given by the equation:

$${P}_{LP} = \frac{1}{2} \cdot {L}_{LP} \cdot {I}_{PP}^{2} \cdot F$$

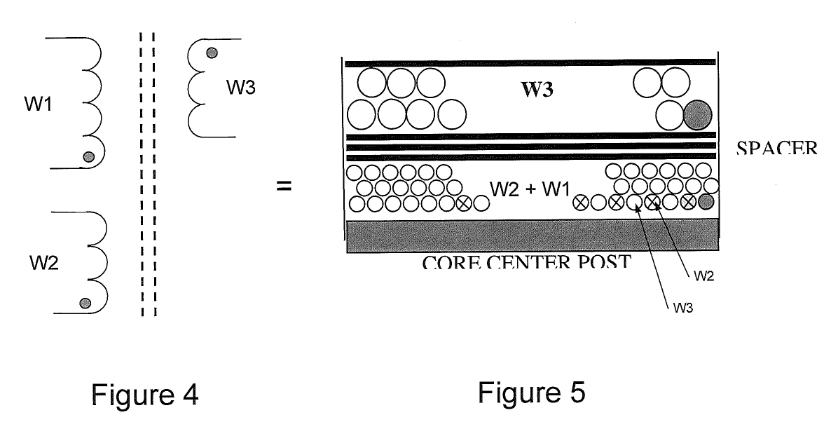

In a typical SMPS, the secondary leakage inductance is minimised in the transformer design process. This has many benefits, including increased efficiency, lower voltage overshoot, and the like. In other SMPS designs, the leakage inductance may be controlled to some particular value (i.e. not minimised) for other purposes. For example, in primary-sensing flyback SMPS applications, it is desirable to power the control electronics in such a way that does not influence the amount of power delivered to the output. In this case, the leakage inductance power can be harvested on the primary side and used to power the control electronics. This power harvesting can be achieved by closely coupling the auxiliary winding (W2) to the primary winding, (W1) controlling carefully the physical separation distance between the primary (W1) and secondary windings (W3). As may be seen in FIG. 5, the auxiliary winding (comprising a few turns) is wound together with the start of the primary winding (comprising a large number of turns). This method effectively embeds W2 into W1, optimising their mutual coupling A spacer (typically a number of turns of transformer tape) provides a defined separation distance between the primary/auxiliary windings and the secondary winding, to give primary-secondary leakage inductance to suit the desired application circuit. In effect, this arrangement minimises the effective leakage inductances L_{LP} (21) and L_{LA} (22), but gives a controlled value for L_{LS} (23) as defined in the equivalent simplified circuit FIG. 2a.

There is also energy stored in the interwinding primary capacitance which results in power loss. By closely coupling the switched end of the primary winding to the auxiliary winding, some of the energy in the interwinding primary capacitance can be recovered for use in powering the control circuit.

With the auxiliary and primary windings arranged as above, the interwinding capacitance between them can be significant, amounting to, say, 15 pF in a typical phone charger design. The capacitive energy stored in the primary-auxiliary capacitor C_{PA} (30) when charged to the peak primary voltage V_{PP} is given by the equation

$${E}_{M} = \frac{1}{2} \cdot {C}_{PA} \cdot {V}_{PP}^{2}$$

Therefore, the amount of power which may be recovered for powering the control circuit when switched at frequency F is given by

$${P}_{M} = \frac{1}{2} \cdot {C}_{PA} \cdot {V}_{PP}^{2} \cdot F$$

For example, for C_{PA}=15ₚF, F=40 KHz (say) and Vₚₚ=600V, P_{M}; 100 mW. When the primary switch is cycled, the leakage inductance power (generated by the current flowing in L_{LP}) and the interwinding capacitance power (generated by the voltage switched across C_{PA}) may be recycled or dissipated via the diode 17 on the auxiliary winding 15. This is advantageous because it reduces the cost of implementing a snubber (if required) and allows the recycling of leakage inductance power to supply the control circuits, improving efficiency.

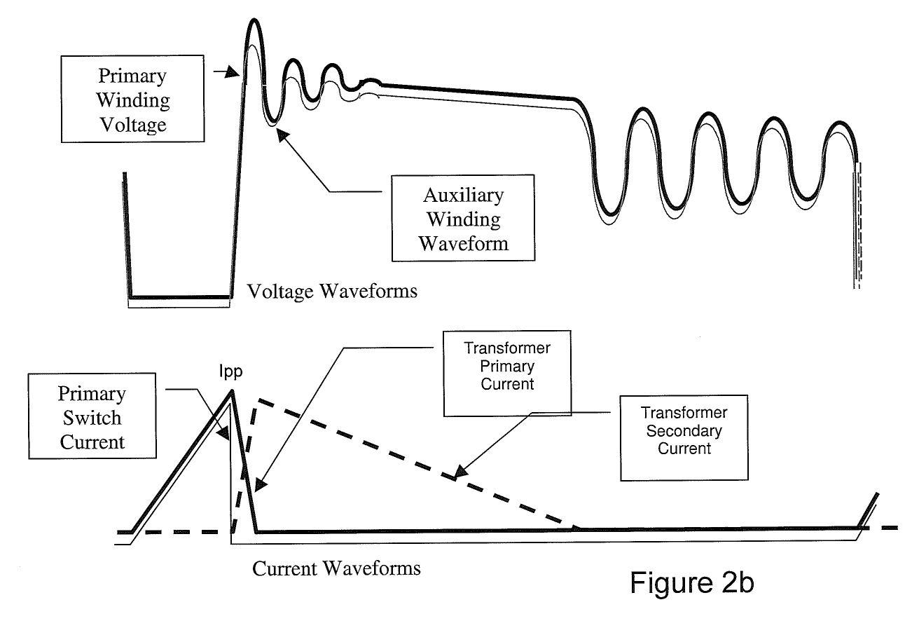

If a zener diode (25) were connected as shown in FIG. 3, then the peak voltage of the auxiliary winding (W2) would be clamped at a voltage determined by the zener diode voltage. Because of the strong inductive and capacitive coupling between W2 and W1, clamping W2 has the effect of also clamping the peak voltage on the primary winding W1. A benefit of this arrangement is that snubbing is achieved by the addition of a single low cost zener diode, as compared to the cost of adding conventional snubbing which requires higher cost, high voltage components. Additionally or alternatively, the leakage inductance power could be diverted from the secondary leakage inductance via the diode 17 and auxiliary winding 15 to the control circuit, represented by the current sink (26). One benefit of this arrangement is that the auxiliary rail is supplied without diverting power from the output, making it possible to estimate the output current quite accurately in a primary-sensing controlled SMPS design. Another benefit is that the control circuit can be supplied with power irrespective of the loading on the secondary side. In some embodiments of the circuit it is possible to completely remove the snubber circuit, not only increasing conversion efficiency but also reducing system component costs.

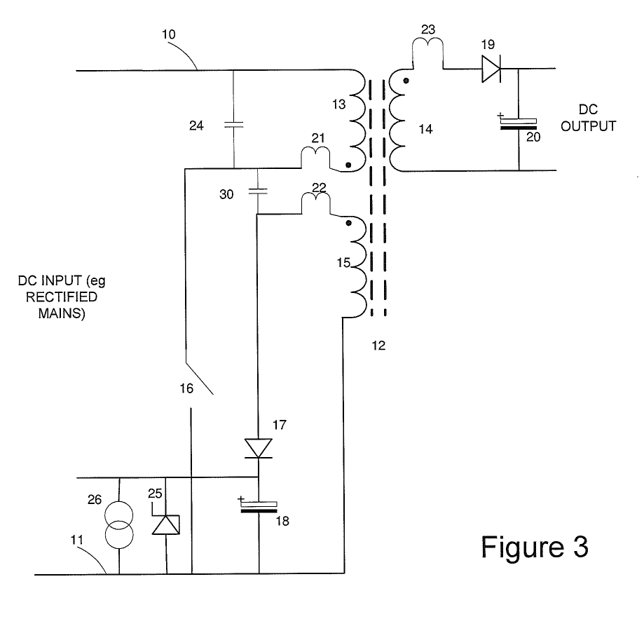

FIG. 4 shows a schematic diagram of the transformer; FIG. 5 shows a possible arrangement of the primary (W1), auxiliary (W2) and secondary windings (W3) according to the method described. Of particular importance is the intimate contact between windings W1 and W2 providing strong inductive and capacitive coupling.

The amount of inductive coupling and capacitance between the primary and auxiliary windings (W1, W2) is mainly dependent upon the number of auxiliary and primary turns and their proximity to one another. The method of coupling transformer windings described here allows the leakage inductance and cross-capacitance to be controlled to a desirable value.

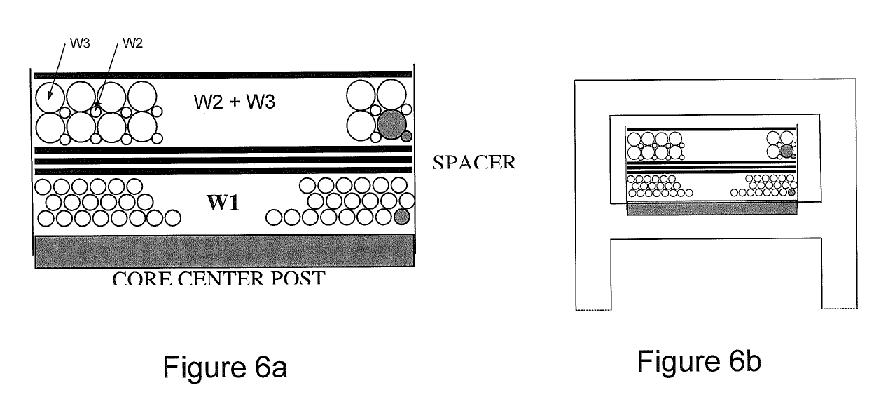

FIG. 5 shows only half the transformer cross section (for clarity); a mirror image half of the cross section would appear below that shown. (FIG. 6b illustrates the relation of these windings to the core). The open and dark circles in the cross section of the transformer follow a convention in which a dark, filled circle indicates a start position for putting a winding onto a bobbin of the transformer. Thus in FIG. 5 both the windings W1 and W2 begin adjacent to one another, adjacent to the core centre post, in the illustrated example at one end of the centre post.

Accurately Sensing Secondary Winding Voltage

In some SMPS applications, such as flyback power supplies, it is important to sense the secondary voltage accurately, without compromising safety or incurring unnecessary cost. The primary-sensing power converter does this by monitoring an auxiliary transformer winding, so that, after applying appropriate scaling, the output voltage and status may be estimated. However, the unwanted parasitic elements of primary-leakage inductance make this difficult. Furthermore, it is important to minimise RF emissions, which largely originate from the capacitive coupling of primary noise sources (such as the primary switching) to the secondary, as well as the capacitive coupling of secondary noise sources (such as the secondary rectifier switching) to the primary. This can be mitigated by noise cancellation, which may be achieved by allowing a degree of capacitive coupling between the secondary and auxiliary windings.

A variant of the technique outlined earlier allows the secondary winding voltage to be accurately sensed, by changing the winding order and therefore the coupling of the auxiliary winding, as shown in FIG. 6. Winding W1 is wound first. Windings W2 and W3 are wound together, ensuring strong inductive and capacitive coupling between them. Preferably W3 is isolated by using triple insulated wire. Again, a spacer may be interposed to weaken the coupling between W1 and the others.

The strong mutual inductance between the auxiliary (W2) and secondary (W3) windings, together with the weak coupling between the primary and secondary windings allows the output winding voltage to be accurately sensed by the auxiliary winding.

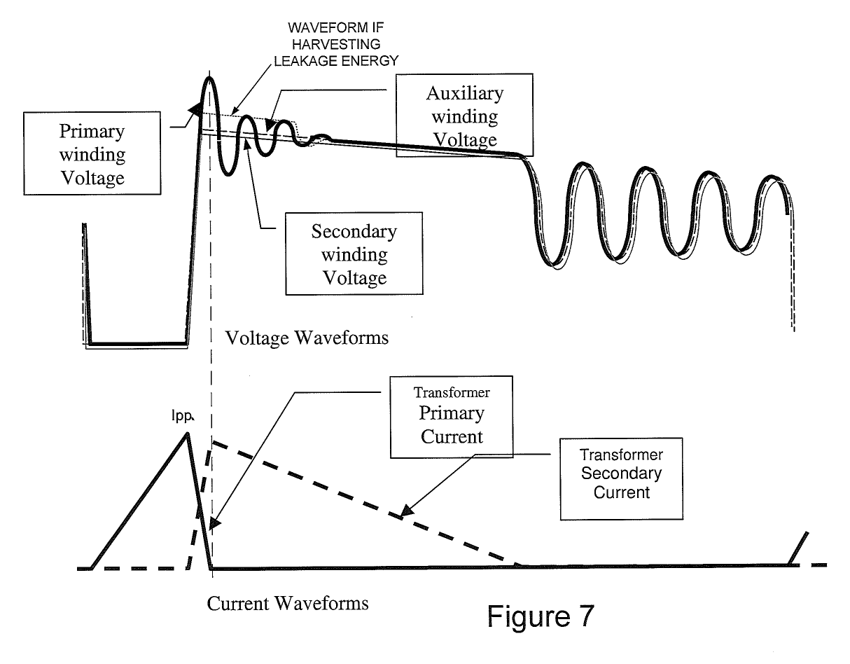

It may be seen in FIG. 7 that the auxiliary sense winding W2 accurately represents the voltage waveform of the secondary winding, making it particularly suitable for, but not limited to, primary-sensing SMPS applications. (The height of the substantially flat portion of the secondary winding voltage is proportional to V_{OUT}). Furthermore, the RF emissions may be mitigated to some degree by the strong capacitive coupling which is presented between the secondary and auxiliary windings. The ripple might have a frequency of, for example 1-10 MHz, say ˜2 MHz. The waveform of harvesting leakage energy is also shown.

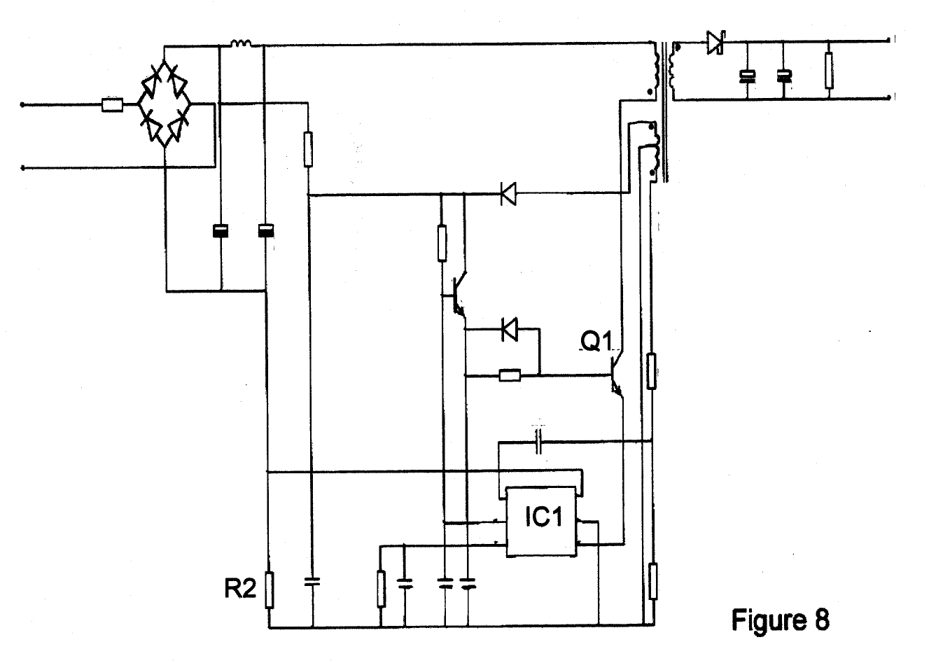

Referring now to FIG. 8, this shows a complete circuit diagram of an example of an SMPS embodying aspects of the present invention as described above. In this example SMPS the primary side switch comprises a bipolar transistor Q1 with a switched emitter (effectively switching V_{BE}) with the primary side current passing through the controller, IC1. As well as primary side voltage sensing the SMPS also incorporates primary side current side sensing using a current sense resistor, R2.

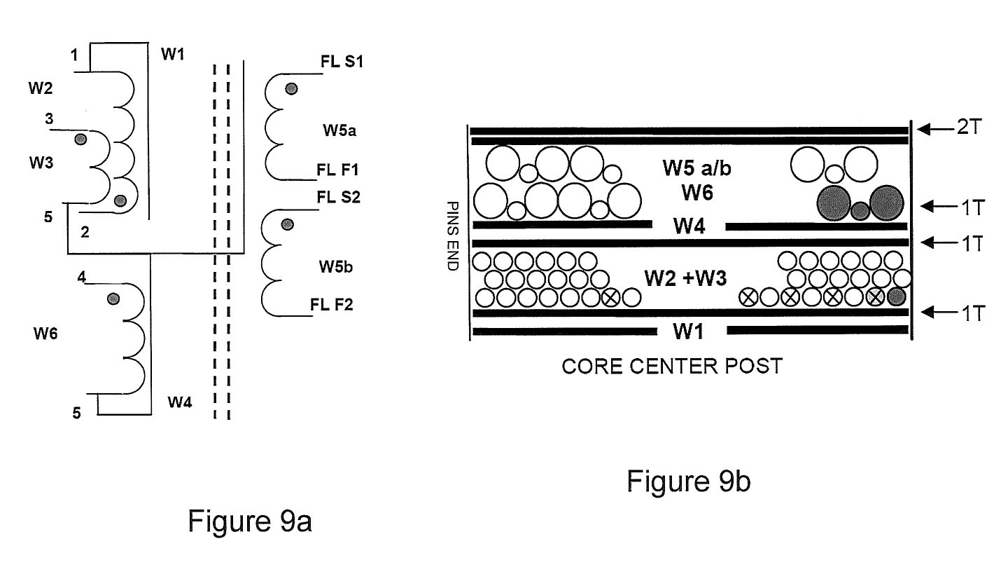

FIG. 9 shows a transformer for the SMPS of FIG. 8, including a pair of primary-to-secondary shield foils as illustrated, preferably combined with a shorted flux band, to reduce common mode noise. A core gap may be employed to provide a desired inductance factor; flying leads are preferably used for the secondary winding connections to allow for creepage and clearance. An example construction employs an E16 bobbin; polyester tape; copper foil; enamelled copper wire and, for the secondary winding, triple insulated wire (such as TEX-E).

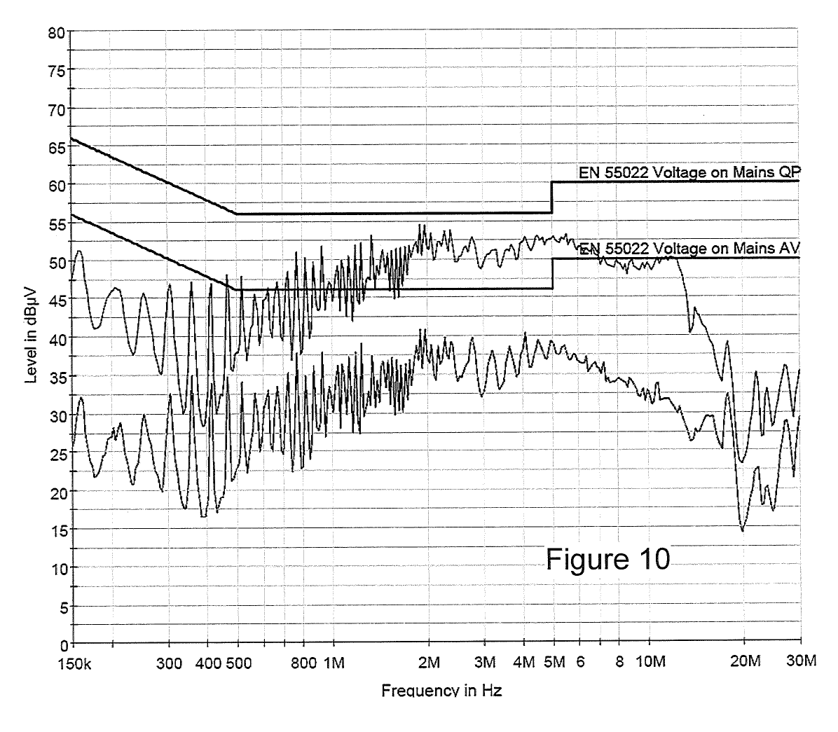

FIG. 10 shows a graph of measured noise level in dB μV against frequency in Hz showing a first regulatory limit according to EN standard EN55022 for noise measured according to a quasi-peak measurement technique, and a second regulatory limit defined by EN55022 for noise measured according to an averaging technique (lower line).

No doubt many other effective alternatives will occur to the skilled person. It will be understood that the invention is not limited to the described embodiments and encompasses modifications apparent to those skilled in the art lying within the spirit and scope of the claims appended hereto.

1. A switch mode power supply (SMPS), said switched-mode power supply comprising a power input, a switch, a transformer, and a power output; said transformer comprising a primary winding on a primary side of said power supply coupled to said power input via said switch, and a secondary winding on a secondary side of said switched-mode power supply coupled to said power output; wherein said transformer further comprises first and second auxiliary windings, wherein said first auxiliary winding is more closely coupled to said primary winding than to said secondary winding and wherein said second auxiliary winding is more closely coupled to said secondary winding than to said primary winding.

2. A switched-mode power supply as claimed in claim 1 further comprising a controller to control said switch and a power supply circuit for said controller coupled to be powered by said first auxiliary winding.

3. A switched-mode power supply as claimed in claim 2 wherein said power supply circuit is configured to provide power to said controller when an output voltage of said SMPS falls to substantially zero.

4. A switched mode power supply as claimed in claim 1 further comprising at least one of a voltage clamping component and a voltage clamping circuit connected to the auxiliary winding, to thereby provide partial clamping of the switched primary winding.

5. A switched-mode power supply as claimed in claim 1 configured for primary side sensing of an output voltage of said SMPS, and wherein said primary side sensing is configured to employ said second auxiliary winding.

6. A switched-mode power supply as claimed in claim 5, further comprising a controller to control said switch, and wherein said controller is configured to sense a voltage on said secondary side of said SMPS by sensing a voltage on said second auxiliary winding.

7. A switched-mode power supply as claimed in claim 1 wherein said transformer further comprises a spacer to physically separate said first and second auxiliary windings from one another.

8. A switched-mode power supply as claimed in claim 1 wherein at least one of layers and turns of said primary winding and said first auxiliary winding are interleaved.

9. A switched-mode power supply as claimed in claim 1 wherein at least one of layers and turns of said secondary winding and said second auxiliary winding are interleaved.

10. A switched-mode power supply as claimed in claim 1 wherein said first and second auxiliary windings are electrically connected to one another.

11. A switched-mode power supply as claimed in claim 1 wherein said SMPS is a flyback SMPS.

12. A method of providing a power supply to the controller of a switched-mode power supply (SMPS), said switched-mode power supply including a power input, a switch, a transformer and a power output; said transformer including a primary winding on a primary side of said power supply coupled to said power input via said switch, and a secondary winding on a secondary side of said switched-mode power supply coupled to said power output, wherein said transformer further comprises an auxiliary winding, in operation of said SMPS said auxiliary winding including a voltage waveform with a ringing component when said switch turns off, said ringing component comprising energy stored in leakage inductance and stray capacitance of said SMPS, the method comprising extracting energy to power said controller of said SMPS from said ringing component of said auxiliary winding voltage.

13. A method of providing a power supply to the SMPS controller as claimed in claim 12 wherein said SMPS comprises an output characteristic including a substantially constant current portion in which an output voltage of said SMPS falls towards zero at substantially constant output current with increasing output load, and wherein said energy is extracted from said ringing component as said output voltage falls to substantially zero.

14. A method of providing a power supply to the SMPS controller as claimed in claim 12 further comprising winding said auxiliary winding interleaved with said primary winding.

15. A switched-mode power supply, said switched-mode power supply including a power input, a switch, a controller to control said switch, a transformer, and a power output; said transformer including a primary winding on a primary side of said power supply coupled to said power input via said switch, and a secondary winding on a secondary side of said switched-mode power supply coupled to said power output, and wherein said transformer further comprises an auxiliary winding to provide a power supply for said controller, in operation of said SMPS said auxiliary winding including a voltage waveform with a ringing component when said switch turns off, said ringing component comprising energy stored in leakage inductance and stray capacitance of said SMPS, said switched-mode power supply further comprising means for extracting energy to power said controller of said SMPS from said ringing component of said auxiliary winding voltage.

16. A method of suppressing emissions from a switched-mode power supply (SMPS) said switched-mode power supply including a power input, a switch, a transformer, and a power output; said transformer including a primary winding on a primary side of said power supply coupled to said power input via said switch, and a secondary winding on a secondary side of said power supply coupled to said power output, wherein said transformer further comprises an auxiliary winding to sense a voltage on said secondary side of said SMPS, and wherein said SMPS includes a controller to control said switch in response to said sensed voltage, the method comprising winding said auxiliary winding interleaved with said secondary winding and coupling each of said secondary winding and said auxiliary winding to a reference voltage connection on respectively said secondary side and said primary side of said SMPS.

17. A switched-mode power supply said switched-mode power supply including a power input, a switch, a transformer, and a power output; said transformer including a primary winding on a primary side of said power supply coupled to said power input via said switch, and a secondary winding on a secondary side of said power supply coupled to said power output, wherein said transformer further comprises an auxiliary winding, wherein said auxiliary winding is interleaved with said secondary winding, and wherein each of said secondary winding and said auxiliary winding is coupled to a reference voltage connection on respectively said secondary side and said primary side of said SMPS.

18. A switched-mode power supply (SMPS) said switched-mode power supply including a power input, a switch, a controller to control said switch, a transformer, and a power output; said transformer including a primary winding on a primary side of said power supply and coupled to said power input via said switch, and a secondary winding on a secondary side of said power supply coupled to said power output, wherein said transformer further comprises an auxiliary winding to provide a power supply for said controller, wherein said SMPS comprises an output characteristic including a substantially constant current portion in which an output voltage of said SMPS falls towards zero at substantially constant output current with increasing output load, and wherein said power supply for said controller is configured to provide power for said controller as said output voltage falls from a maximum value at said substantially constant output current to a voltage of less than one third of said maximum value.

19. A switched-mode power supply as claimed in claim 18 wherein said power supply for said controller is configured to provide power for said controller as said output voltage falls from a maximum value at said substantially constant output current to a voltage of less than one tenth of said maximum value.
